(19) United States
(12) Patent Application Publication
(10) Pub. No.: US 2016/0196607 A1
(43) Pub. Date: Jul. 7, 2016

(54) Method For Indicating Divergence Signals Of Securities Related Technical Indicators

(71) Applicant: Fonestock Technology Inc., Taipei (TW)

(72) Inventors: Chu Tsung Chen, Taipei City (TW); Kuan Hao Huang, Taipei (TW); Yi Hsuan Kuo, Taipei (TW)

(73) Assignee: Fonestock Technology Inc., Taipei (TW)

(21) Appl. No.: 14/980,933

(22) Filed: Dec. 28, 2015

(30) Foreign Application Priority Data
Jan. 5, 2015 (TW) 104100021

(51) Int. Cl. G06Q 40/04; G06F 17/30

(52) U.S. Cl. CPC G06Q 40/04; G06F 17/30312

(57) ABSTRACT

A method for indicating divergence signals of securities related technical indicators is employed in a securities information processing system which comprises a server and a mobile device. The user can operate the mobile device to select and set-up multiple individual stocks and a time interval, and the server will check if there is any divergence signal occurred on any selected individual stock during the time interval. When there is any divergence signal found during the check, the server sends the result of check to the mobile device, and then the result will be shown on the mobile device as a matrix table. The user may watch and take this matrix table as a reference to decide when to buy or sell the individual stock.

This application claims the benefit of Taiwan Patent Application Serial No. 104100021, filed Jan. 5, 2015, the subject matter of which is incorporated herein by reference.

### BACKGROUND OF INVENTION

1. Field of the Invention

The invention relates to a method for indicating divergence signals of securities related technical indicators, and more particularly to an alerting method that can automatically advise an occurrence of a divergence signal of a securities-related technical indice on an individual stock during a specific time period.

2. Description of the Prior Art

As information technology progress, people express their special needs in real-time and convenient information accessibility and their desires in advanced communicative devices. Various new multi-functional portable wireless communication devices are presented to the marketplace in an unprecedented fashion and an astonished speed, and all of which are simply to meet versatile and quick-changing demands. These communication devices includes various cellular phones, smart phones, devices with real-time stock info function, personal digital assistants, tablet computers, notebook computers, and any electronic device with wireless communication function.

Except for the aforesaid wireless communication devices, various software and apps are provided to those devices so as further to satisfy users in manifolds of convenience, real-time communication, in-time financing, jobs, entertainments, information accessing and so on. For example, specific wireless communication devices have facilitated the electronic trading for exchanging stocks, futures and the like valuable securities. The electronic service provided by the aforesaid devices can include the order-placing and more significantly the information sourcing of security trading information for helping the user to judge a prospective security and to also determine the trade timing for his/her own valuable securities.

For a user who trades valuable securities frequently, the trend line of a specific security regarding historical or intraday trading is usually an important reference for predicting future trading of this specific security. By observing the historical trend lines for the concerned security, the user can better understand possible trend of this security and thus can organize a feasible trading scheme for this security. In particular, as these trend lines are accompanied by divergence signals of specific technical indicators such as, but not limited to, the volumes, the KD indicators, the RSI indicators, the MACD indicators, the OBV indicators and so on, it presents explicitly that a change in the progress of the trend line might come, and thus a preferable trade timing for the related stocks is surfaced.

Hence, if an alerting method for indicating divergence signals of securities related technical indicators can be provided to automatically check the majority of the enormous security trading information, and can furnish an automatic alerting function to advise divergence signals of some specific technical indicators for specific securities/stocks that have met some predetermined patterns of trend lines. Then, the user may gain more help in predicting the timing for buy or sell and in determining the trading price for the security or stocks.

Nevertheless, among all the technical analytic data and the related services from the security-related companies, these data and services usually use a plenty amount of terminologies and professional words in the security field, people who want to utilize these technical analytic data and the related services from the security-related companies need to get familiar with these terminologies and professional words in advance, and further need to able to handle the mathematical algorithms for these technical analysis. Hence, for those people who don't have the related knowledge in the security field, it is hard to be beneficial from the help of the analytical indicators (not limited to the trend lines and the divergence signals of technical indicators) in determining both the pricing and the timing for trading the securities. Definitely, the nowadays visual-plot display method to further help users in a more straightforward way in determining the investment timing of the interested security.

### SUMMARY OF THE INVENTION

Accordingly, it is the primary object of the present invention to provide a method for indicating divergence signals of securities related technical indicators, implemented in a security information processing system, can allow the user of the mobile device to select and set-up the individual stock and the time interval. When there is any divergence signal found for the individual stock within the time interval, this situation would be automatically shown on the mobile device for alerting the user so as to help the user when to buy or sell the individual stock.

In one embodiment of the present invention, the occurrence of the divergence signal of the individual stock is displayed in a graphic, visualized and tablized manner, such that the user can aware visually and instinctly the classiciation of the divergence signal of the individual stock even that the user does not have sufficient understanding in professional securities knowledge. Upon such an arrangement, ordinary people can easily utilize the securities related trend-line patterns and the divergence signal of the technical indicator to decide favoritely when to buy or sell the individual stock.

In the present invention, the method for indicating divergence signals of securities related technical indicators, implemented in a security information processing system, the security information processing system including a server and at least one mobile device, the server capturing a plurality of trading information of a plurality of individual stocks from an external information source and storing the plurality of trading information into a database, comprising the steps of:

Step (A): the server basing on the trading information stored in the database to calculate a technical graph within a time interval for the plurality of individual stocks, at least two band highs or band lows in the technical graph, and at least one technical indicator with respect to a position of each of the at least two band highs or band lows;

Step (B): the server basing on the at least two band highs or band lows and the at least one technical indicator with respect to the position of each of the at least two band highs or band lows to calculate if or not there is a divergence signal of the technical indicator for any of the plurality of individual stocks within the time interval, and storing a result of calculation for the divergence signal of each the individual stock into the database;

Step (C): the mobile device sending a check request of divergence signal to the server; wherein, in one embodiment of the invention, the check request includes at least one individual stock to be checked; however, in another embodiment of the invention, the check request does not need to include the individual stock to be checked, and instead, the check request includes a request to retrieve a list of individual stocks which recently incur divergence signals;

Step (D): the server basing on the check request to retrieve the result of calculation of the divergence signal for at least one individual stock from the database and then forward to the mobile device; and

Step (E): the mobile device displaying the received divergence signal of the individual stock on a screen of the mobile device.

In one embodiment of the present invention, the method for indicating divergence signals of securities related technical indicators further includes a step of a user operating the mobile device to configure the check request (step of configuring the check request), wherein the step of configuring the check request is performed at one of a time before the step (A) and a time between the step (B) and the step (C).

In one embodiment of the present invention, the step of configuring the check request is an operational step of the user operating the mobile device to configure a user-favor individual stock listing.

In one embodiment of the present invention, in the step (E), the divergence signal is displayed on the screen of the mobile device as a matrix table, the matrix table being a M*N matrix formed by a listing of M names of the individual stocks to be checked and a listing of N said technical indicators, the M and the N being positive integers; wherein a situation of any of the individual stocks to be checked showing the divergence signal of any technical indicator existing in the result of calculation would be labeled in the matrix table, such that the user can be aware of the specific individual stock to be checked showing the divergence signal of the specific technical indicator by simply observing the matrix table.

In one embodiment of the present invention, the step (E) further includes a step of showing a commercial page and a step of advising the user to purchase merchandise after the user clicks the commercial page.

In one embodiment of the present invention, in the step (E), when the mobile device is operated to click the divergence signal of any said individual stock on the screen, the screen would further display the technical graph, the at least two band highs or band lows, and the at least one technical indicator with respect to the position of each of the at least two band highs or band lows of the individual stock.

In one embodiment of the present invention, the method for computing the trend line of Step (A) includes the following steps.

Step (A1): A plurality of historical trading records regarding the individual stock within the time interval is searched and then retrieved from the memory of the mobile device, and a technical graph is formed according to the historical trading records.

Step (A2): Locate a plurality of band highs and a plurality of band lows on the technical graph.

Step (A3): According to the band highs and the band lows, label the respective trend line corresponding to the band highs and the band lows.

In one embodiment of the present invention, the technical graph includes a plurality of K bars (candlesticks) formed in accordance with the plurality of the historical trading records. In Step (A2), the method for locating the plurality of band highs and the plurality of band lows includes the following criteria.

Criterion 1: Define the closing price of the first K bar within the time interval as a reference point of rule 1, and compare the closing price of the following K bar to the reference point of rule 1 of this K bar. If the closing price of the following K bar is higher than the reference point of rule 1 of this K bar, then the reference point of rule 1 is updated by the closing price of the following K bar. If the closing prices of the following m number of K bars are all lower than the reference point of rule 1, then label the reference point of rule 1 as a band high of rule 1. Wherein, the number m is an integral, and 2≦m≦8; wherein in this embodiment, m=3. According to Criterion 1, all the band highs (LH1˜LHn) of rule 1 within the time interval can be located, in which the LH1 stands for the first band high of rule 1 meeting Criterion 1 within the time interval, and the LHn stands for the n-th band high of rule 1 meeting Criterion 1 within the time interval.

Criterion 2: Define the closing price of the first K bar within the time interval as a reference point of rule 2, and compare the closing price of the following K bar to the reference point of rule 2 of this K bar. If the closing price of the following K bar is lower than the reference point of rule 2 of this K bar, then the reference point of rule 2 is updated by the closing price of the following K bar. If the closing prices of the following m number of K bars are all higher than the reference point of rule 2, then label the reference point of rule 2 as a band low of rule 1. According to Criterion 2, all the band lows (LL1˜LLn) of rule 2 within the time interval can be located, in which the LL1 stands for the first band low of rule 2 meeting Criterion 2 within the time interval, and the LLn stands for the n-th band low of rule 2 meeting Criterion 2 within the time interval.

Criterion 3: Define the closing price of the last K bar within the time interval as a reference point of rule 3, and compare the closing price of the preceding K bar to the reference point of rule 3 of this K bar. If the closing price of the preceding K bar is higher than the reference point of rule 3 of this K bar, then the reference point of rule 3 is updated by the closing price of the preceding K bar. If the closing prices of the preceding m number of K bars are all lower than the reference point of rule 3, then label the reference point of rule 3 as a band high of rule 3. According to Criterion 3, all the band highs (RH1˜RHn) of rule 3 within the time interval can be located, in which the RH1 stands for the first band high of rule 3 meeting Criterion 3 within the time interval, and the RHn stands for the n-th band high of rule 3 meeting Criterion 3 within the time interval.

Criterion 4: Define the closing price of the last K bar within the time interval as a reference point of rule 4, and compare the closing price of the preceding K bar to the reference point of rule 4 of this K bar. If the closing price of the preceding K bar is lower than the reference point of rule 4 of this K bar, then the reference point of rule 4 is updated by the closing price of the preceding K bar. If the closing prices of the preceding m number of K bars are all higher than the reference point of rule 4, then label the reference point of rule 4 as a band low of rule 4. According to Criterion 4, all the band lows (RL1˜RLn) of rule 4 within the time interval can be located, in which the RL1 stands for the first band low of rule 4 meeting Criterion 4 within the time interval, and the RLn stands for the n-th band low of rule 4 meeting Criterion 4 within the time interval.

In the aforesaid criteria, the number n is an integer greater than zero.

In one embodiment of the present invention, the method for determining and then labeling the at least one trend line in Step (A3) further includes the following steps. In the following description, define the symbol N(•) as the number of “•”.

Step (A31): A trend-line pattern of the trend line is judged by comparing the numbers of the band highs and the band lows as follows.

If N(LH)>N(RH) and N(RL)>N(LL), then the pattern of the trend line is defined as an upward trend track.

If N(LL)>N(RL) and N(RH)>N(LH), then the pattern of the trend line is defined as a downward trend track.

If N(LH)>N(RH) and N(LL)>N(RL), then the pattern of the trend line is defined as a divergent trend track.

If N(RH)>N(LH) and N(RL)>N(LL), then the pattern of the trend line is defined as a convergent trend track.

Step (A32): Base on the result of Step (A31) to determine and label the at least one trend line as follows.

If the pattern of the trend line is an upward trend track, then locate the maximum value of the LHs, and connect the LH maximum value with each LH. Define and label an upward resistance line of the upward trend track to the connection line that is the closest to have a zero slope (from a positive slope side). Then, locate the minimum value of the RLs, and connect the RL minimum value with each RL. Define and label an upward support line of the upward trend track to the connection line that is the closest to have a zero slope (from a positive slope side).

If the pattern of the trend line is a downward trend track, then locate the minimum value of the LLs, and connect the LL minimum value with each LL. Define and label a downward support line of the downward trend track to the connection line that is the closest to have a zero slope (from a negative slope side). Then, locate the maximum value of the RHs, and connect the RH maximum value with each RH. Define and label a downward resistance line of the downward trend track to the connection line that is the closest to have a zero slope (from a negative slope side).

If the pattern of the trend line is a divergent trend track, then locate the maximum value of the LHs, and connect the LH maximum value with each LH. Define and label an upward resistance line of the divergent trend track to the connection line that is the closest to have a zero slope (from a positive slope side). Then, locate the minimum value of the LLs, and connect the LL minimum value with each LL. Define and label a downward support line of the divergent trend track to the connection line that is the closest to have a zero slope (from a negative slope side).

If the pattern of the trend line is a convergent trend track, then locate the maximum value of the RHs, and connect the RH maximum value with each RH. Define and label a downward resistance line of the convergent trend track to the connection line that is the closest to have a zero slope (from a negative slope side). Then, locate the minimum value of the RLs, and connect the RL minimum value with each RL. Define and label an upward support line of the convergent trend track to the connection line that is the closest to have a zero slope (from a positive slope side).

In one embodiment of the present invention, the Step (A) and the Step (B) are performed once by the server at a predetermined time after closing of the trade date.

All these objects are achieved by the method for indicating divergence signals of securities related technical indicators described below.

### BRIEF DESCRIPTION OF THE DRAWINGS

The present invention will now be specified with reference to its preferred embodiment illustrated in the drawings, in which:

FIG. 1 shows schematically an embodiment of a security information processing system for performing an method for indicating divergence signals of securities related technical indicators in accordance with the present invention;

FIG. 2 is a flowchart of an embodiment of the method for indicating divergence signals of securities related technical indicators in accordance with the present invention;

FIG. 3 shows schematically an embodiment of the technical graph in the method for indicating divergence signals of securities related technical indicators in accordance with the present invention;

FIG. 4 shows schematically an embodiment for displaying the divergence signals in the method for indicating divergence signals of securities related technical indicators in accordance with the present invention;

FIG. 5 demonstrates schematically a pop-up of a commercial page in front of the window of FIG. 4;

FIG. 6 shows schematically a further change of FIG. 5 after clicking the commercial page therein;

FIG. 7 is a flowchart for computing the technical line pattern of the individual stock in the method for indicating divergence signals of securities related technical indicators in accordance with the present invention; and

FIG. 8 is a result of trend lines obtained from performing steps of FIG. 7.

### DESCRIPTION OF THE PREFERRED EMBODIMENT

The invention disclosed herein is directed to a method for indicating divergence signals of securities related technical indicators. In the following description, numerous details are set forth in order to provide a thorough understanding of the present invention. It will be appreciated by one skilled in the art that variations of these specific details are possible while still achieving the results of the present invention. In other instances, well-known components are not described in detail in order not to unnecessarily obscure the present invention.

In the present invention, the method for indicating divergence signals of securities related technical indicators is employed in a securities information processing system which comprises a server and a mobile device. In one embodiment of the invention, the user can operate the mobile device to select and set-up multiple individual stocks and a time interval, and the server will check if there is any divergence signal occurred on any selected individual stock during the time interval. However, in another embodiment of the invention, the user does not need to set-up multiple individual stocks, and instead, the user only need to operate the mobile device to send a check request to retrieve a list of individual stocks which recently incur divergence signals to the server. When there is any divergence signal found during the check, the server sends the result of check to the mobile device, and then the result will be shown on the mobile device as a matrix table. The user may watch and take this matrix table as a reference to decide when to buy or sell the individual stock. In the present invention, the occurrence of the divergence signal of the individual stock is displayed in a graphic, visualized and tablized manner; such that the user can aware visually and instinctly the classiciation of the divergence signal of the individual stock even that the user does not have sufficient understanding in professional securities knowledge. Upon such an arrangement, ordinary people can easily utilize the securities related trend-line patterns and the divergence signal of the technical indicator to decide favoritely when to buy or sell the individual stock.

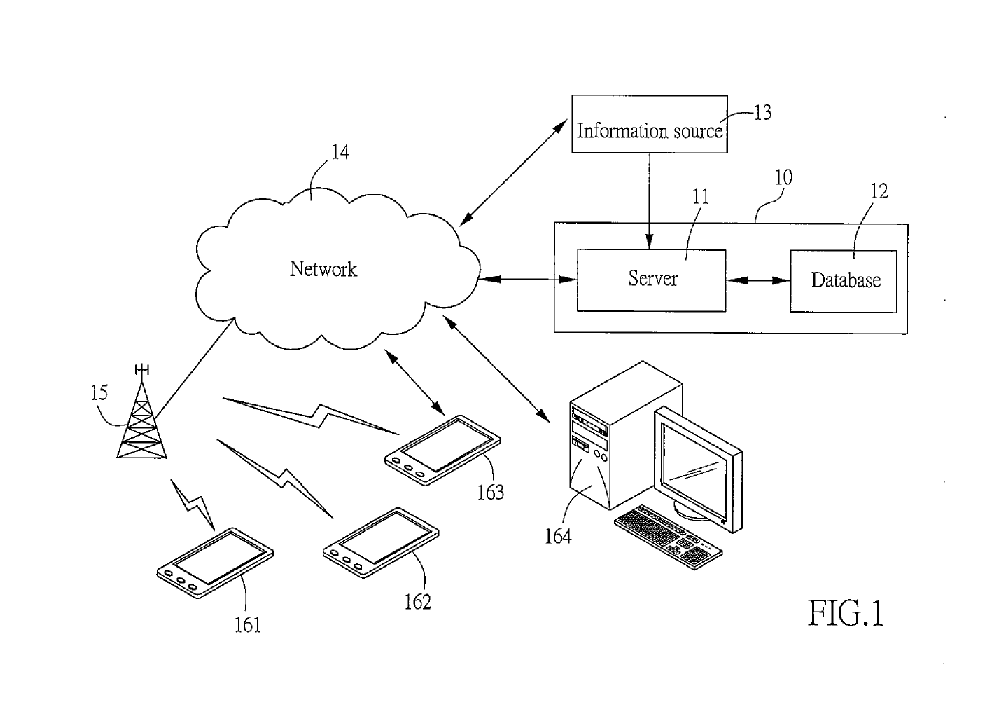

Referring now to FIG. 1, an embodiment of a security information processing system for fulfilling the method for indicating divergence signals of securities related technical indicators in accordance with the present invention is shown in a block diagram.

This embodiment of the security information processing system includes a server 11, at least one database 12, an information source 13, a communicative medium 14, a communicative servicing system 15, and a plurality of mobile devices 161, 162, 163, 164. The server 11 and the database 12 are integrally to form a security information servicing system 10. The server 11 can receive a plurality of security trading information from the at least one information source 13, perform an analysis upon the received security trading information, and then store the analytic results into the at least one database 12. The server 11 can receive connection requests from and then establish the connection with a plurality of mobile devices 161, 162, 163, 164 via a communicative medium 14. As the communicative connections are established, the mobile devices 161, 162, 163, 164 can log in the server 11 to further access the service provided by the server 11, which the service includes, but not limited to, download the trading information or static data of the security stored in the at least one database 12 from the server and so on. In the present invention, the trading information or statistic data of the security are commonly called as the security information.

The data connection among the mobile devices 161, 162, 163, 164, the server 11 and the information source 13 can be established by utilizing the communicative medium 14 provided by the at least one communicative servicing system 15. In this embodiment, the security information processing system 10 is to provide information service regarding the valuable securities, in which the valuable securities includes, but not limited to, stocks, futures, warrants, funds, bonds and so on. The information source 13 or sources is/are the source/sources accessible to the server 11 and the mobile devices 161, 162, 163, 164, and can include, but not limited to, real-time or/and historical databases provided by security exchanges, security dealers, banks, news, television and broadcast media, private enterprises and so on. The communicative servicing system 15 can be, but not limited to, GSM850/900/1800/1900, a CDMA, a WCDMA, a PHS, a GPRS, a WiMAX, an LTE and any system the like. The mobile devices 161, 162, 163, 164 can be, but not limited to, stock machines having a touch screen, PDAs, smart phones, the like handheld electronic devices, tablets, notebooks or desktop computers having a touch screen. The communicative medium 14 can include at least one of a mobile-phone communicative medium, a wireless network communicative medium, and a network medium.

In the present invention, the method for indicating divergence signals of securities related technical indicators can be implemented in any of the mobile devices 161, 162, 163, 164 of the security information processing system. The mobile devices 161, 162, 163, 164 can include individually respective touch screens and memories for the user to operate through touching the specific touch screen, so as to allow the specific mobile device to perform the method for indicating divergence signals of securities related technical indicators.

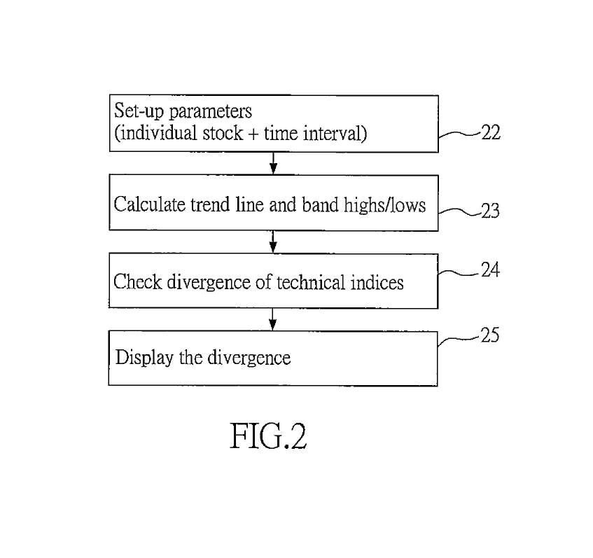

In FIG. 2, a flowchart for an embodiment of the method for indicating divergence signals of securities related technical indicators in accordance with the present invention is shown. This embodiment of the method includes the following steps.

Step 22: Set-up parameters (individual stock+time interval). The user operates the mobile device to configure a check request (step of configuring the check request), in which the check request is to request the server for capturing of the result of check upon the divergence signal of the securities related technical indicator. In one embodiment of the present invention, the step of configuring the check request is an operational step of the user operating the mobile device to select, input or configure a user-favor individual stock listing. Namely, the step is to configure a listing of personal preferable individual stocks, securities sectors, stock sectors, or weighted price indicators of the stock exchange. As long as the user completes the setting of the user-favor individual stock listing, the mobile device would forward the individual stock listing to the server and store it in the database. In this embodiment, the user can also operate the mobile device to configure a time interval to be inquired. Only the trading information within the time interval would be calculated and checked upon an occurrence of a divergence of specific technical indicators. However, in another embodiment of the present invention, the time interval can be a predetermined time interval already stored in the server, such as, but not limited to, a 60-day interval, an interval to include recent 60 trading records and so on. Such a predetermined time interval in the server can't be altered anyway through the operation of the mobile device by the user. In yet another embodiment of the invention, the user does not need to set-up parameters for any individual stock, and instead, the user only need to operate the mobile device to send a check request to retrieve a list of individual stocks which recently incur divergence signals to the server. And then, based on the check request, the server will retrieve the result of calculation of the divergence signals for individual stocks from the database and then forward to the mobile device.

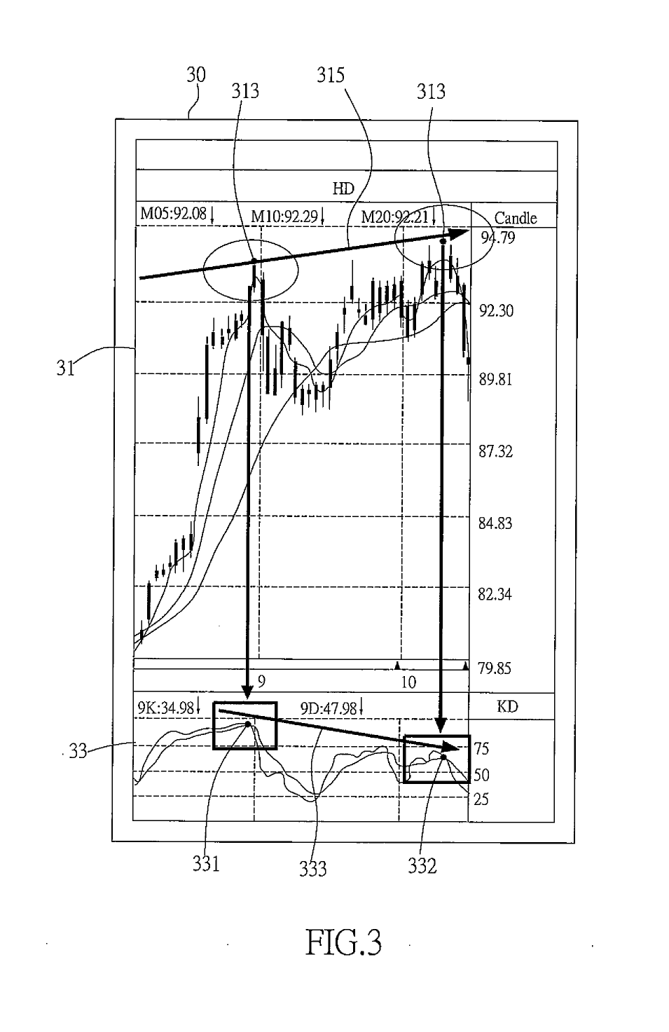

Step 23: Calculate the trend line and the band highs/lows. The server can capture a plurality of trading information of a plurality of individual stocks from an external information source and stored them into a database. The trading information includes real-time and/or historical securities information. The historical securities information can include any historical trading record regarding the individual stock within the time interval, such as open prices, intraday highs, intraday lows, closing prices, trading volumes, and any trading record the like for any day, any week, any month, any season and any specific time the like. Then, the server bases on the trading information stored in the database to calculate a technical graph 31 within the time interval for the plurality of individual stocks, at least two band highs 313 or band lows in the technical graph 31, and at least one technical indicator 331 or 332 with respect to a position of each of the at least two band highs 313 or band lows. In FIG. 3, an embodiment of the technical graph 31 in the method for indicating divergence signals of securities related technical indicators in accordance with the present invention is schematically shown. Details for computing the trend line and the band highs/lows would be discussed later in this disclosure.

Step 24: Check divergence of technical indicators. As shown in FIG. 3, the server bases on the at least two band highs 313 or band lows and the at least one technical indicator 331 or 332 with respect to the position of each of the at least two band highs 313 or band lows to calculate if or not there is a divergence signal of the technical indicator for any of the plurality of individual stocks within the time interval, and stores a result of calculation for the divergence signal of each the individual stock into the database. Details for computing divergence signal of the technical indicator would be discussed later in this disclosure.

Then, when the user intends to know if any divergence signal of the technical indicator happens to any individual stock within the time interval configured by the user herself/himself or preset by the server, the user can operate the mobile device to transmit a check request of divergence signal to the server. In one embodiment of the present invention, whenever the user clicks a “Divergence Stock” on a touch screen of the mobile device, the mobile device would automatically generate the check request and forward it to the server, and the server would base on the individual stocks in the user-favor individual stock listing of the respective mobile device pre-stored in the database to define the individual stocks to be checked. Hence, in this embodiment, the user needn't to select one by one the individual stocks to be inquired. However, in another embodiment of the present invention, whenever the user clicks a “Divergence Stock” on a touch screen of the mobile device, the mobile device would automatically generate the check request and forward it to the server, wherein the check request does not include the user-favor individual stock listing, and then the server would check all of the individual stocks in its database to see if any individual stock recently incurs divergence signals. Hence, in this embodiment, the user also needn't to select one by one the individual stocks to be inquired. The step of the user operating the mobile device to configure the user-favor individual stock listing is a part of the step 22, namely performed prior to the step 23, however is yet optional. In this embodiment, the step 23 and the step 24 are performed once by the server at a predetermined time after closing of each trade date, for example, but not limited to, at one hour later after the closing while the system might be in off-peak hours. The execution of the step 23 and the step 24 might be a complete calculation and analysis upon all the individual stocks, stock sectors, weighted price indice of the stock exchange and the like trading information, such that all the technical line patterns, band highs/lows, technical indicators and the divergence signals for the individual stocks, stock sectors, weighted price indice of the stock exchange and the like trading information within the time interval can be obtained, and the results of calculation would be stored in the database for possible inquiry from other mobile devices.

In another embodiment of the present invention, after the user clicks the “Divergence Stock” on the touch screen of the mobile device, the user can keep going to operate the mobile device to select the interested individual stocks. Thereafter, the mobile device would base on the user-selected individual stocks to define the individual stocks to be checked, and generate the corresponding check request accordingly. Then, the check request including the individual stocks to be checked is transmitted to the server. In another embodiment of the present invention, the step of the user operating the mobile device to select the interested individual stocks can be performed in the step 22 (namely, before the step 23), or at a time between the step 24 and the step 25. While the step of the user operating the mobile device to select the interested individual stocks is performed in the step 22, the server can wait the check request from the mobile device to arrive and then perform the calculation of the steps 23 and 24 so as to obtain all the technical line patterns, band highs/lows, technical indicators and the divergence signals upon the individual stocks to be checked included in the check request. On the other hand, while the step of the user operating the mobile device to select the interested individual stocks is performed between the step 24 and the step 25, at a timing after a predetermined time after the closing of the trade date, the server would perform a complete calculation and analysis upon all the individual stocks, stock sectors, weighted price indice of the stock exchange and the like trading information, such that all the technical line patterns, band highs/lows, technical indicators and the divergence signals for the individual stocks, stock sectors, weighted price indice of the stock exchange and the like trading information within the time interval can be obtained, and the results of calculation would be stored in the database for possible inquiry from other mobile device.

Since the check of the step 24 upon the divergence of specific technical indicator is finished, then when the mobile device the check request of the divergence signal is transmitted to the server. After the server receives the check request from the mobile device, the server would base on the received check request including the individual stocks to be checked to retrieve, from the database, the result of calculation of the divergence signal for the individual stocks with respect to the individual stock to be checked, and then transmit the result to the mobile device.

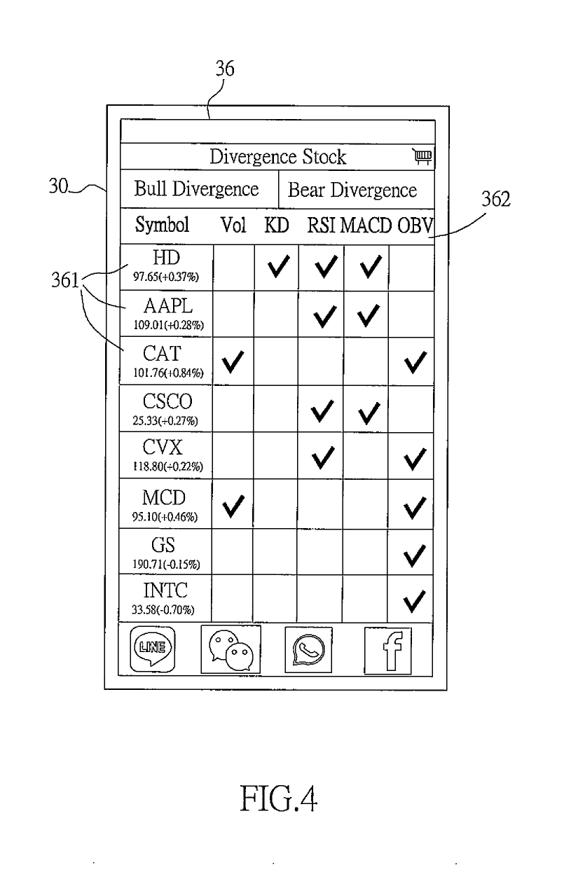

Step 25: Display the divergence. The mobile device displays the received divergence signal/signals of the individual stocks on the touch screen 30 of the mobile device for the user to judge a better time for the individual stocks to buy or sell. In FIG. 4, an embodiment for displaying the divergence signals in the method for indicating divergence signals of securities related technical indicators in accordance with the present invention is schematically shown. As shown, the divergence signals are illustrated in a matrix table 36 on the touch screen 30 of the mobile device. The matrix table 36 mainly formed as an M*N matrix includes a listing of names 361 for M individual stocks to be checked and a listing of N technical indicators 362, in which the M and the N are both positive integers. In this embodiment, any situation of any of the individual stocks to be checked showing the divergence signal of any technical indicator existing in the result of calculation would be labeled in the matrix table 36, such that the user can be aware of the specific individual stock to be checked showing the divergence signal of the specific technical indicator by simply observing the matrix table 36. Since the occurrence of the divergence signal of the individual stock is displayed in a graphic, visualized and tablized manner; such that the user can aware visually and instinctly the classiciation of the divergence signal of the individual stock even that the user does not have sufficient understanding in professional securities knowledge. Upon such an arrangement, ordinary people can easily utilize the securities related trend-line patterns and the divergence signal of the technical indicator to decide favoritely when to buy or sell the individual stock.

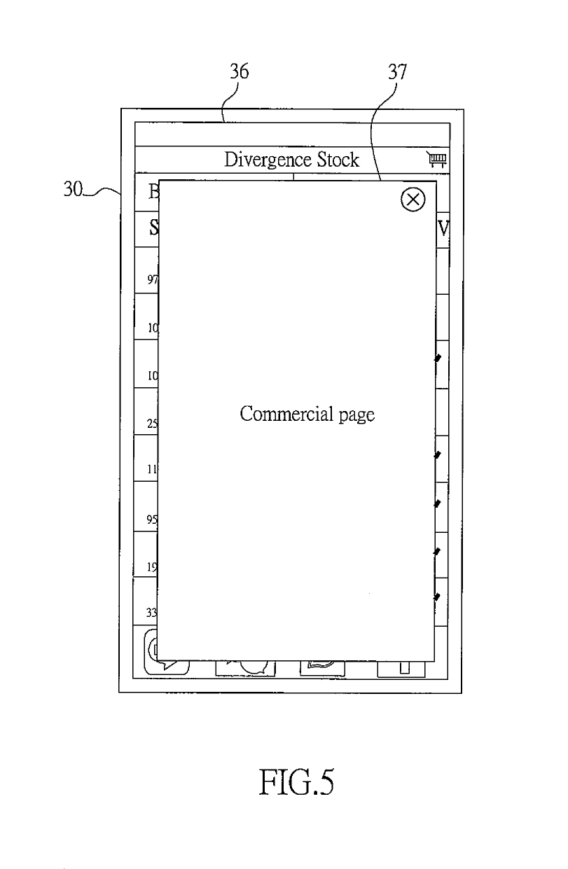

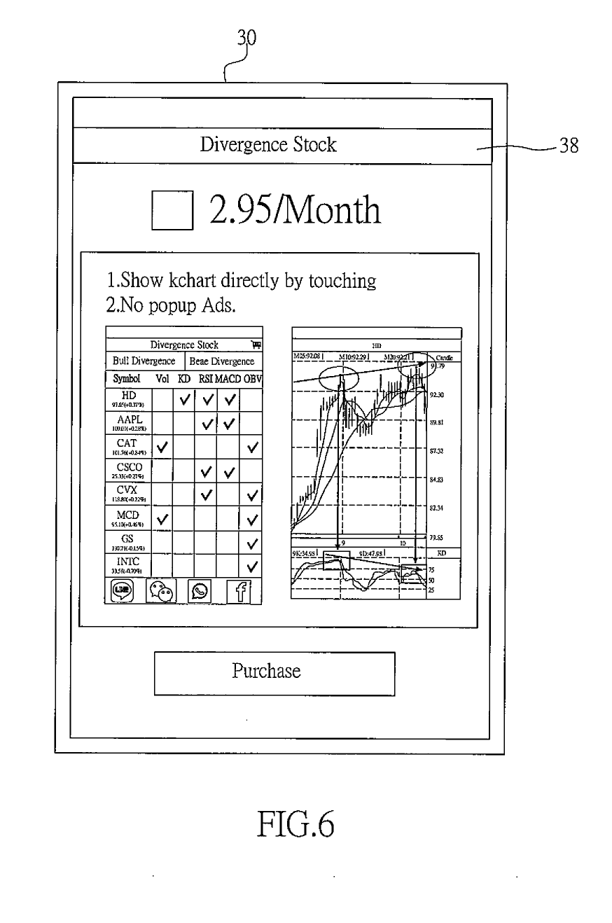

In one embodiment of the present invention, the service of going through the mobile device to check and display the result of check of the divergence signals for specific technical indicators can be provided by the securities related service provider (i.e. the server end) for free or in a minor charge. However, as shown in FIG. 5, while in displaying the matrix table 36 of the result of checking the divergence signals, a commercial page 37 might be simultaneously popped up to shade a portion or completely the displayed result of check (i.e. the matrix table 36). At this time, the user may operate the mobile device to close the window displaying the commercial page 37, or click the commercial page 37 to further obtain an page for advising the user to purchase merchandise. For example, as shown in FIG. 6, after the commercial page 37 is clicked, an addition operational page 38 for advising the user to purchase merchandise provided by the server end or the securities related service provider would be displayed. For example, but not limited to, a purchase may initiate a further detail displaying upon the technical line patterns, the positions of the band highs/lows, the technical indicators with respect to each of the band highs/lows, and the divergence signals for specific technical indicators related to the individual stocks in the matrix table 36. As long as the additional purchase function is subscribed by the user, in the step 25, when the mobile device is operated to click any of the individual stocks and the divergence signals displayed in the matrix table 36 on the screen 30, the screen would display further the technical graphs, the at least two band highs or band lows, and the at least one technical indicator with respect to each position of the at least two band highs or band lows for the individual stock; namely, the technical graph 31 and the related information shown in FIG. 3.

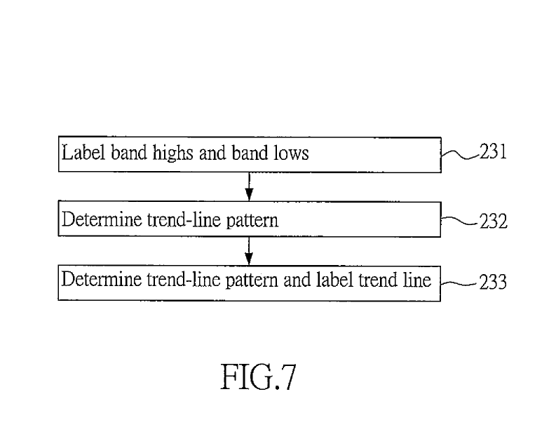

Referring now to FIG. 7, a flowchart of an embodiment of the method for computing the trend line (in Step 23) for the method for indicating divergence signals of securities related technical indicators of the present invention is shown. As shown, the method for computing the trend line includes the following steps.

Firstly, a plurality of historical trading records regarding the individual stock within the time interval is searched and then retrieved from the memory of the mobile device. Based on the historical trading records, a technical graph is formed, in which the technical graph includes a plurality of candlesticks (K bars) regarding the individual stock within the time interval.

Then, perform Step 231 to label band highs and band lows. In this step, a plurality of band highs and a plurality of band lows are located and then labeled on the technical graph.

In one embodiment of the present invention, the method for sorting the band highs and the band lows in the Step 231 can include the following criteria.

Criterion 1: Define the closing price of the first K bar within the time interval as a reference point of rule 1, and compare the closing price of the following K bar to the reference point of rule 1 of this K bar. If the closing price of the following K bar is higher than the reference point of rule 1 of this K bar, then the reference point of rule 1 is updated by the closing price of the following K bar. If the closing prices of the following m number of K bars are all lower than the reference point of rule 1, then label the reference point of rule 1 as a band high of rule 1. According to Criterion 1, all the band highs (LH1˜LHn) of rule 1 within the time interval can be located, in which the LH1 stands for the first band high of rule 1 meeting Criterion 1 within the time interval, and the LHn stands for the n-th band high of rule 1 meeting Criterion 1 within the time interval.

Criterion 2: Define the closing price of the first K bar within the time interval as a reference point of rule 2, and compare the closing price of the following K bar to the reference point of rule 2 of this K bar. If the closing price of the following K bar is lower than the reference point of rule 2 of this K bar, then the reference point of rule 2 is updated by the closing price of the following K bar. If the closing prices of the following m number of K bars are all higher than the reference point of rule 2, then label the reference point of rule 2 as a band low of rule 1. According to Criterion 2, all the band lows (LL1˜LLn) of rule 2 within the time interval can be located, in which the LL1 stands for the first band low of rule 2 meeting Criterion 2 within the time interval, and the LLn stands for the n-th band low of rule 2 meeting Criterion 2 within the time interval.

Criterion 3: Define the closing price of the last K bar within the time interval as a reference point of rule 3, and compare the closing price of the preceding K bar to the reference point of rule 3 of this K bar. If the closing price of the preceding K bar is higher than the reference point of rule 3 of this K bar, then the reference point of rule 3 is updated by the closing price of the preceding K bar. If the closing prices of the preceding m number of K bars are all lower than the reference point of rule 3, then label the reference point of rule 3 as a band high of rule 3. According to Criterion 3, all the band highs (RH1˜RHn) of rule 3 within the time interval can be located, in which the RH1 stands for the first band high of rule 3 meeting Criterion 3 within the time interval, and the RHn stands for the n-th band high of rule 3 meeting Criterion 3 within the time interval.

Criterion 4: Define the closing price of the last K bar within the time interval as a reference point of rule 4, and compare the closing price of the preceding K bar to the reference point of rule 4 of this K bar. If the closing price of the preceding K bar is lower than the reference point of rule 4 of this K bar, then the reference point of rule 4 is updated by the closing price of the preceding K bar. If the closing prices of the preceding m number of K bars are all higher than the reference point of rule 4, then label the reference point of rule 4 as a band low of rule 4. According to Criterion 4, all the band lows (RL1˜RLn) of rule 4 within the time interval can be located, in which the RL1 stands for the first band low of rule 4 meeting Criterion 4 within the time interval, and the RLn stands for the n-th band low of rule 4 meeting Criterion 4 within the time interval.

In the aforesaid criteria, the number n is an integer greater than zero.

Then, perform Step 232 to judge the pattern of the trend line. According to the band highs and the band lows, the pattern of the trend line in the technical graph can be determined.

In one embodiment of the present invention, the aforesaid trend-line pattern of Step 232 is judged by comparing the numbers of the band highs and the band lows as follows. In the following description, define the symbol N(•) as the number of “•”.

If N(LH)>N(RH) and N(RL)>N(LL), then the pattern of the trend line is defined as an upward trend track.

If N(LL)>N(RL) and N(RH)>N(LH), then the pattern of the trend line is defined as a downward trend track.

If N(LH)>N(RH) and N(LL)>N(RL), then the pattern of the trend line is defined as a divergent track.

If N(RH)>N(LH) and N(RL)>N(LL), then the pattern of the trend line is defined as a convergent track.

Then, perform Step 233 to determine and label the trend line onto the technical graph. According to the band highs and the band lows, label the trend line corresponding to the band highs and the band lows.

In one embodiment of the present invention, the method to determine the trend line in Step 233 is to base on the trend-line pattern judged in Step 232 to perform the labeling of the trend line on the technical graph. The determination method of the trend line is explained as follows.

If the pattern of the trend line is an upward trend track, then locate the maximum value of the LHs, and connect the LH maximum value with each LH. Define and label an upward resistance line of the upward trend track to the connection line that is the closest to have a zero slope (from a positive slope side). Then, locate the minimum value of the RLs, and connect the RL minimum value with each RL. Define and label an upward support line of the upward trend track to the connection line that is the closest to have a zero slope (from a positive slope side).

If the pattern of the trend line is a downward trend track, then locate the minimum value of the LLs, and connect the LL minimum value with each LL. Define and label a downward support line of the downward trend track to the connection line that is the closest to have a zero slope (from a negative slope side). Then, locate the maximum value of the RHs, and connect the RH maximum value with each RH. Define and label a downward resistance line of the downward trend track to the connection line that is the closest to have a zero slope (from a negative slope side).

If the pattern of the trend line is a divergent trend track, then locate the maximum value of the LHs, and connect the LH maximum value with each LH. Define and label an upward resistance line of the divergent trend track to the connection line that is the closest to have a zero slope (from a positive slope side). Then, locate the minimum value of the LLs, and connect the LL minimum value with each LL. Define and label a downward support line of the divergent trend track to the connection line that is the closest to have a zero slope (from a negative slope side).

If the pattern of the trend line is a convergent trend track, then locate the maximum value of the RHs, and connect the RH maximum value with each RH. Define and label a downward resistance line of the convergent trend track to the connection line that is the closest to have a zero slope (from a negative slope side). Then, locate the minimum value of the RLs, and connect the RL minimum value with each RL. Define and label an upward support line of the convergent trend track to the connection line that is the closest to have a zero slope (from a positive slope side).

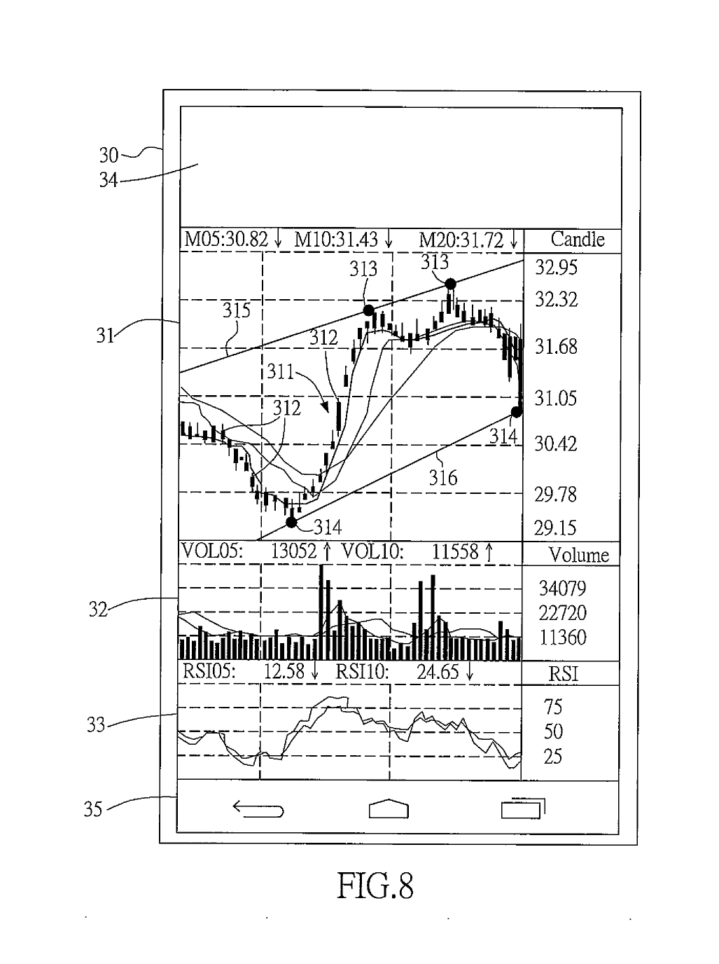

Referring now to FIG. 8, a result of trend lines obtained from performing steps of FIG. 7 is shown in accordance with the method for indicating divergence signals of securities related technical indicators of the present invention, in which FIG. 8 shows an upward trend track of the trend line.

As long as the band high/low 313, 314 of the technical line pattern 31 for any said individual stock are obtained and the related trend lines 315, 316 are organized, further check upon the divergence of the technical indicators 32, 33 for the individual stock within the time interval can be performed. Firstly, according to the aforesaid steps for computing the trend line, the band highs/lows 313, 314 can be located. Then, select two neighboring highs or lows 313, 314 to calculate values of the technical indicators (such as Volume, KD, RSI, MACD, OBV, CCI and the like technical indicators 32, 33) with respect to the selected two neighboring band highs 313 or band lows 314 at the same timing. Then, referring also to FIG. 3, connect the selected two neighboring band highs 313 or band lows so as able to calculate the slope of the trend line 315. Simultaneously, a slope for a line 333 connecting the two values 331, 332 of the technical indicator 33 at the same timing can be also calculated. If the slope of the pricing connection line (i.e. the trend line 315) is positive (negative), but the slope of the line 333 for the technical indicator 33 is negative (positive), namely, the slope of the pricing connection line and the slope of the connection line for the values of the technical indicator go to either way in sign of value, then a “Divergence” is formed. That is to say that the trend of pricing and the trend of the indiced do not go synchronically.

In the present invention, since the calculations of the aforesaid technical indicators such as Volume, KD, RSI, MACD, OBV, CCI and the like indicators are all well known to the art, thus details thereabout would be omitted herein. In the following description, only portion of the well-accepted formula for calculating some of the technical indicators is provided.

(1) Calculation of the K-D indicator:

Derive firstly

RSV (Raw Stochastic Value)=(C_n−L_{n})/(H_{n}−L_{n})*100;

in which the C_n stands for the closing price of the n-th trade date, the L_{n} stands for the lowest closing price in recent n trade dates, and the H_{n} stands for the highest closing price in these recent n trade dates.

K_t=K_[t−1]+a*RSV—t;

D_t=D_[t−1]+a*K_t;

in which the K[0]=D[0]=50, and the a is set to ⅓.

(2) Calculation of the RSI (Relative Strength Indicator):

RSI=100−(100/(1+RS));

in which the RS stands for the Relative Strength (RS)=AUn/And, the AUn stands for the daily average of the upward points for the closing prices within recent n trade dates=Σ(Upeard point_i)/n, and the ADn stands for the daily average of the downward points for the closing prices within recent n trade dates=Σ(Downeard point_i)/n. Namely, RSI=100*AUn/(AUn+ADn).

(3) Calculation of the MACD (Moving Average Convergence-Divergence):

(3.1) Derive the price-demand indicator firstly

P_t=(H_t+L_t+2*C_t)/4;

in which the H_t is the highest price of the trade date t, the L_t is the lowest price of the trade date t, and the C_t is the closing price of the trade date t.

(3.2) Obtain the moving average by selecting a long-term line and a short-term line

En_t=En_[t−1]+2/(1+n)*(P_t−En_[t−1]);

in which the n_t is the exponential moving average (EMA) of the P_t for the trade date n and the n is generally choosed to be 12 or 26.

Namely, E12_t=E12 [t−1]+2/13*(P_t−E12_[t−1]) is the 12-day moving average of the P_t, and E26_t=E26_[t−1]+2/27*(P_t−E26_[t−1]) is the 26-day moving average of the P_t.

(3.3) DIF_t=En_t−Em_t to obtain the difference between these two moving averages MACD_t=MACD_[t−1]+2/(1+h)*(DIF_t−MACD_[t−1]).

(4) Calculation of the OBV (On Balance Volume):

OBV_t=Σvolume_i*(−1)̂k, i=1 to t;

if C_i>C_[i−1] k=even number, and if C_i<C_[i−1] k=odd number.

in which the C_i is the closing price of the instant trade date, and the C_[i−1] is the closing price of the preceding trade date.

Generally, the volume would be positive in an upward trade date, the volume would be negative in a downward trade date, and the volume would not be counted if the closing price is flat. In addition, the OBV is the total of the recent t trade dates.

By providing the method for indicating divergence signals of securities related technical indicators in accordance with the present invention, the user of the mobile device can select and set-up the individual stocks to be checked and the time interval, and the server can display the result of check on the mobile device for the user to observe occurrences of the divergence signals for specific technical indicators upon any individual stock within the time interval so as to help the user to determine the timing for buy or sell of the individual stock. In the present invention, the occurrence of the divergence signal of the individual stock is displayed in a graphic, visualized and tablized manner; such that the user can aware visually and instinctly the classiciation of the divergence signal of the individual stock even that the user does not have sufficient understanding in professional securities knowledge. Upon such an arrangement, ordinary people can easily utilize the securities related trend-line patterns and the divergence signal of the technical indicator to decide favoritely when to buy or sell the individual stock. Upon such an arrangement in method of the present invention, the aforesaid shortcomings in the art can be substantially overcome.

While the present invention has been particularly shown and described with reference to a preferred embodiment, it will be understood by those skilled in the art that various changes in form and detail may be without departing from the spirit and scope of the present invention.

What is claimed is:

1. A method for indicating divergence signals of securities related technical indicators, implemented in a security information processing system, the security information processing system including a server and at least one mobile device, the server capturing a plurality of trading information of a plurality of individual stocks from a foreign information source and storing the plurality of trading information into a database, comprising the steps of:
Step (A): the server basing on the trading information stored in the database to calculate a technical graph within a time interval for the plurality of individual stocks, at least two band highs or band lows in the technical graph, and at least one technical indicator with respect to a position of each of the at least two band highs or band lows;
Step (B): the server basing on the at least two band highs or band lows and the at least one technical indicator with respect to the position of each of the at least two band highs or band lows to calculate if or not there is a divergence signal of the technical indicator for any of the plurality of individual stocks within the time interval, and storing a result of calculation for the divergence signal of each the individual stock into the database;
Step (C): the mobile device sending a check request of divergence signal to the server;
Step (D): the server basing on the check request to retrieve the result of calculation of the divergence signal for at least one individual stock from the database and then forward to the mobile device; and
Step (E): the mobile device displaying the received divergence signal of the individual stock on a screen of the mobile device.

2. The method for indicating divergence signals of securities related technical indicators of claim 1, further including a step of a user operating the mobile device to configure the check request (step of configuring the check request), wherein the step of configuring the check request) is performed at one of a time before the step (A) and a time between the step (B) and the step (C).

3. The method for indicating divergence signals of securities related technical indicators of claim 2, wherein the step of configuring the check request is an operational step of the user operating the mobile device to configure a user-favor individual stock listing.

4. The method for indicating divergence signals of securities related technical indicators of claim 1, wherein, in the step (E), the divergence signal is displayed on the screen of the mobile device as a matrix table, the matrix table being a M*N matrix formed by a listing of M names of the individual stocks to be checked and a listing of N said technical indicators, the M and the N being positive integers; wherein a situation of any of the individual stocks to be checked showing the divergence signal of any technical indicator existing in the result of calculation would be labeled in the matrix table, such that the user can be aware of the specific individual stock to be checked showing the divergence signal of the specific technical indicator by simply observing the matrix table.

5. The method for indicating divergence signals of securities related technical indicators of claim 1, wherein the step (E) further includes a step of showing a commercial page and a step of advising the user to purchase merchandise after the user clicks the commercial page.

6. The method for indicating divergence signals of securities related technical indicators of claim 1, wherein, in the step (E), when the mobile device is operated to click the divergence signal of any said individual stock on the screen, the screen would further display the technical graph, the at least two band highs or band lows, and the at least one technical indicator with respect to the position of each of the at least two band highs or band lows of the individual stock.

7. The method for indicating divergence signals of securities related technical indicators of claim 1, wherein the Step (A) further includes the steps of:
Step (A1): searching a plurality of historical trading records regarding the individual stock within the time interval from the database, and forming a technical graph according to the historical trading records;
Step (A2): locating a plurality of band highs and a plurality of band lows on the technical graph; and
Step (A3): based on the plurality of band highs and the plurality of band lows to determine and label the respective at least one trend line corresponding to the plurality of band highs and the plurality of band lows.

8. The method for indicating divergence signals of securities related technical indicators of claim 7, wherein the technical graph includes a plurality of K bars (candlesticks) formed in accordance with the historical trading records, wherein, in Step (A2), a method for locating the band highs and the band lows includes the following criteria:
Criterion 1: defining a closing price of the first K bar within the time interval as a reference point of rule 1, comparing another closing price of the following K bar to the reference point of rule 1 of this first K bar, updating the reference point of rule 1 by the another closing price of the following K bar if the another closing price of the following K bar is higher than the reference point of rule 1 of this first K bar, and labeling the reference point of rule 1 as a band high of rule 1 if the another closing prices of the following m number of K bars are all lower than the reference point of rule 1, wherein, according to Criterion 1, all the band highs (LH1˜LHn) of rule 1 within the time interval can be located, in which the LH1 stands for the first band high of rule 1 meeting Criterion 1 within the time interval, and the LHn stands for the n-th band high of rule 1 meeting Criterion 1 within the time interval; wherein the number m is an integral, and 2≦m≦8;
Criterion 2: defining a closing price of the first K bar within the time interval as a reference point of rule 2, comparing another closing price of the following K bar to the reference point of rule 2 of this first K bar, updating the reference point of rule 2 by the another closing price of the following K bar if the another closing price of the following K bar is lower than the reference point of rule 1 of this first K bar, and labeling the reference point of rule 2 as a band low of rule 2 if the another closing prices of the following m number of K bars are all higher than the reference point of rule 2, wherein, according to Criterion 2, all the band lows (LL1˜LLn) of rule 2 within the time interval can be located, in which the LL1 stands for the first band low of rule 2 meeting Criterion 2 within the time interval, and the LLn stands for the n-th band low of rule 2 meeting Criterion 2 within the time interval;
Criterion 3: defining a closing price of the last K bar within the time interval as a reference point of rule 3, comparing another closing price of the preceding K bar to the reference point of rule 3 of this last K bar, updating the reference point of rule 3 by the another closing price of the preceding K bar if the another closing price of the preceding K bar is higher than the reference point of rule 3 of this last K bar, and labeling the reference point of rule 3 as a band high of rule 3 if the another closing prices of the preceding m number of K bars are all lower than the reference point of rule 3, wherein, according to Criterion 3, all the band highs (RH1˜RHn) of rule 3 within the time interval can be located, in which the RH1 stands for the first band high of rule 3 meeting Criterion 3 within the time interval, and the RHn stands for the n-th band high of rule 3 meeting Criterion 3 within the time interval; and
Criterion 4: defining a closing price of the last K bar within the time interval as a reference point of rule 4, comparing another closing price of the preceding K bar to the reference point of rule 4 of this last K bar, updating the reference point of rule 4 by the another closing price of the preceding K bar if the another closing price of the preceding K bar is lower than the reference point of rule 4 of this last K bar, and labeling the reference point of rule 4 as a band low of rule 4 if the another closing prices of the preceding m number of K bars are all higher than the reference point of rule 4, wherein, according to Criterion 4, all the band lows (RL1˜RLn) of rule 4 within the time interval can be located, in which the RL1 stands for the first band low of rule 4 meeting Criterion 4 within the time interval, and the RLn stands for the n-th band low of rule 4 meeting Criterion 4 within the time interval;
wherein the number n is an integer greater than zero.

9. The method for indicating divergence signals of securities related technical indicators of claim 8, wherein, in Step (A3), a method for determining and then labeling the at least one trend line includes the steps of:
Step (A31): judging a trend-line pattern of the at least one trend line by comparing numbers of the band highs and the band lows, wherein, defining the symbol N(•) as the number of “•”,
the trend-line pattern of the at least one trend line is defined as an upward trend track if N(LH)>N(RH) and N(RL)>N(LL),
the trend-line pattern of the at least one trend line is defined as a downward trend track if N(LL)>N(RL) and N(RH)>N(LH),
the trend-line pattern of the at least one trend line is defined as a divergent trend track if N(LH)>N(RH) and N(LL)>N(RL), and
the trend-line pattern of the at least one trend line is defined as a convergent trend track if N(RH)>N(LH) and N(RL)>N(LL);
Step (A32): based on the result of Step (A31) to determine and label the at least one trend line,
wherein, if the tread-line pattern of the at least one trend line is the upward trend track, then locate the maximum value of the LHs and connect the LH maximum value with each the LH, defining and labeling an upward resistance line of the upward trend track to a connection line that is the closest to have a zero slope (from a positive slope side), and then also locate the minimum value of the RLs and connect the RL minimum value with each the RL, defining and labeling an upward support line of the upward trend track to a connection line that is the closest to have a zero slope (from a positive slope side);
wherein, if the tread-line pattern of the at least one trend line is the downward trend track, then locate the minimum value of the LLs and connect the LL minimum value with each the LL, defining and labeling a downward support line of the downward trend track to a connection line that is the closest to have a zero slope (from a negative slope side), and then also locate the maximum value of the RHs and connect the RH maximum value with each the RH, defining and labeling a downward resistance line of the downward trend track to a connection line that is the closest to have a zero slope (from a negative slope side);
wherein, if the tread-line pattern of the at least one trend line is a divergent trend track, then locate the maximum value of the LHs and connect the LH maximum value with each the LH, defining and labeling an upward resistance line of the divergent trend trac to a connection line that is the closest to have a zero slope (from a positive slope side), and then also locate the minimum value of the LLs and connect the LL minimum value with each the LL, defining and labeling a downward support line of the divergent trend track to a connection line that is the closest to have a zero slope (from a negative slope side);
wherein, if the tread-line pattern of the at least one trend line is a convergent trend track, then locate the maximum value of the RHs and connect the RH maximum value with each the RH, defining and labeling a downward resistance line of the convergent trend track to a connection line that is the closest to have a zero slope (from a negative slope side), and then also locate the minimum value of the RLs and connect the RL minimum value with each the RL, defining and labeling an upward support line of the convergent trend track to a connection line that is the closest to have a zero slope (from a positive slope side).
